(19) United States
(12) Patent Application Publication
(10) Pub. No.: US 2005/0060893 A1
(43) Pub. Date: Mar. 24, 2005

(54) Electric hand clipper in particular for cutting animal hairs

(76) Inventor: Bernard Comminges, Nantes (FR)

Correspondence Address: YOUNG & THOMPSON, 745 SOUTH 23RD STREET, 2ND FLOOR, ARLINGTON, VA, 22202, US

(21) Appl. No.: 10/498,808

(22) PCT Filed: Dec. 20, 2002
(86) PCT No.: PCT/FR02/04478

(30) Foreign Application Priority Data
Dec. 21, 2001 (FR) 01/16665

(51) Int. Cl. B26B 19/02

(52) U.S. Cl. 30/216

(57) ABSTRACT

The invention concerns an electric hand clipper in particular for cutting animal hairs, comprising a body housing an electric motor (3) for actuating, in reciprocating movement, via an oscillating pin (4), a clipper head cutting comb. Said clipper is characterized in that it comprises between the motor output shaft (3A) and the oscillating pin (4), housed inside the body, a thin planetary gear unit (7) for increasing the torque between the motor output shaft (3A) and the oscillating pin (4), thereby providing a constant no-load speed charging the cutting member and the motor (3). The invention is useful for clipping domestic animal hairs.

The present invention relates to a handheld electric clipper for cutting particularly the hair of animals, of the type comprising a body containing an electric motor to actuate, with reciprocating movement, by means of an oscillating finger, a cutting comb of the clipper head.

Clipping animals with thick fleece at present causes, in addition to an extended care time, a mediocre quality of clipping due to insufficient power which generates too weak an oscillation of the combs and as a result a messy cutting of the hair. Moreover, there occurs a rapid heating of the clipper, which requires interrupting the shearing operation to await complete cooling of the clipper. All these drawbacks are due to the design of the clippers whose motor output shaft is either an endless screw which acts on an eccentric pinion, itself engaging by means of a connecting piece an oscillating finger driving a cutting comb of the clipper, or a drive shaft with eccentric ball bearings acting directly on the oscillating finger driving a cutting comb of the clipper.

In the patent GB 1021615, there is proposed a clipper comprising a speed reducer which is mentioned as having a planetary friction action. This document also describes a state of the art constituted by gearing speed reducers which are of limited effectiveness and of complicated design. In the clipper described in British patent 1021615, the speed reducer is constituted by a housing free in rotation, by two roller ball bearings mounted within the housing, by two rings on which the rolling rings are fixed, one ring being free and the other ring being fixed to the electric motor shaft. The rings have on their bend surface grooves with balls which ensure the adjustment of the couple as a function of the load. The speed reduction device in this case requires on the one hand a friction drive, on the other hand a variation of the couple by means of balls which move within bearings. There results an extremely complicated device which does not permit guaranteeing constant speed when empty and when loaded, of the cutting member. Moreover, the qualification of the speed reducer as described in this document as a reducer having a planetary friction action is erroneous, because at no time do the pinions intervene, contrary to the system of the planetary reducer type in which the reduction takes place by engagement. The speed reducer mentioned for this clipper is thus not a planetary reducer.

An object of the present invention is to provide an electric clipper whose design permits maintaining a constant speed empty and loaded, of the comb of the clipper without heating this latter by increase of the couple transmitted between the motor output shaft and the oscillating finger.

Another object of the present invention is to provide an electric clipper whose design permits reducing, because of the absence of heating and an increase of the quality of cutting, a reduction of the treatment time without increasing the overall cost of such a clipper and without modifying the power of the motor used.

To this end, the invention has for its object an handheld electric clipper for cutting particularly the hair or animals, of the type comprising a body containing an electric motor to actuate, with reciprocating movement, by means of an oscillating finger, a cutting comb in the head of the clipper, characterized in that it comprises, between the motor output shaft and the oscillating finger, disposed within the body, a planetary reducer of small thickness to increase the couple between the motor output shaft and the oscillating finger, thereby to obtain a constant speed empty and loaded of the cutting members and of the motor.

The presence of a planetary reducer with engagement permits the increase of the couple transmitted without increasing proportionately the power of the motor used and thereby obtaining a constant speed empty and loaded of the cutting member and of the motor without giving rise to heating of said clipper.

The invention will be better understood from a reading of the following description of examples of embodiment, with reference to the accompanying drawings, in which:

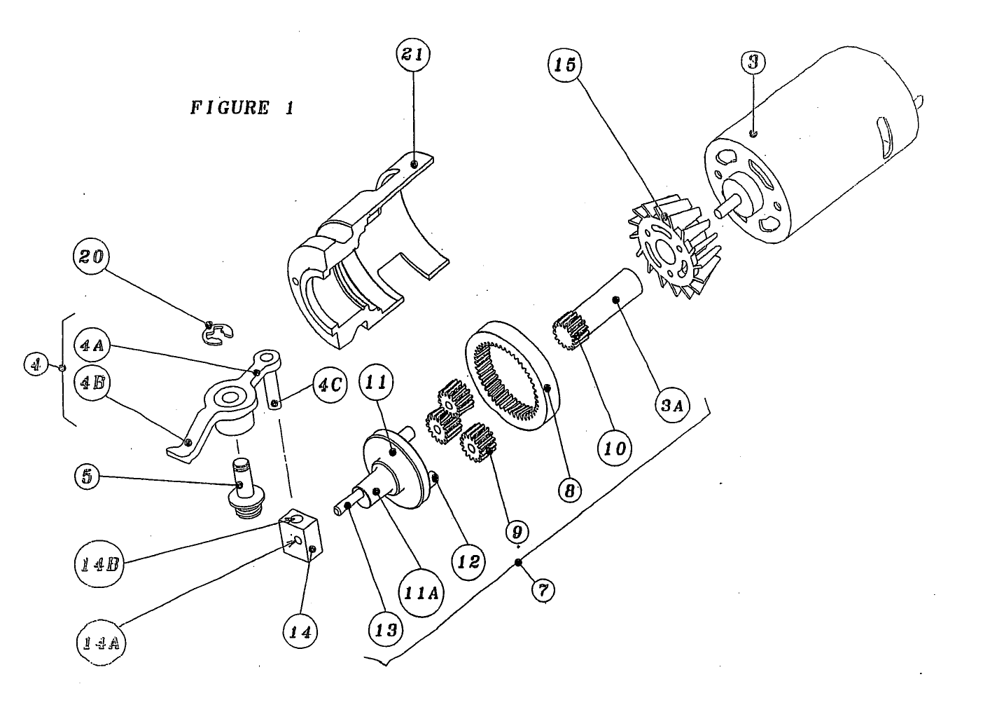

FIG. 1 shows a view partially in perspective of the constituent elements of the clipper disposed within the body of this latter in exploded position of said elements;

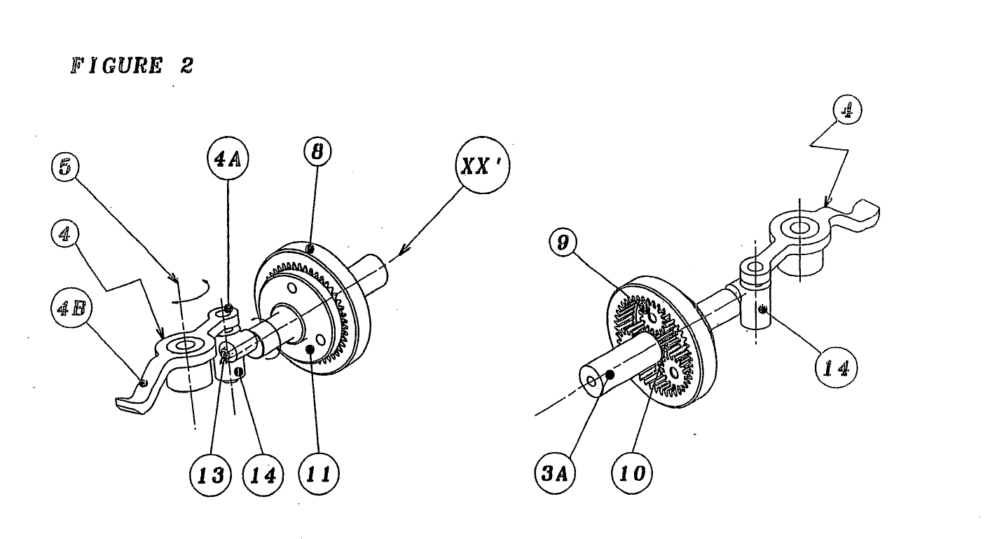

FIG. 2 shows respectively in view in front perspective and a view in rear perspective of the planetary reducer in engagement with the oscillating finger, and

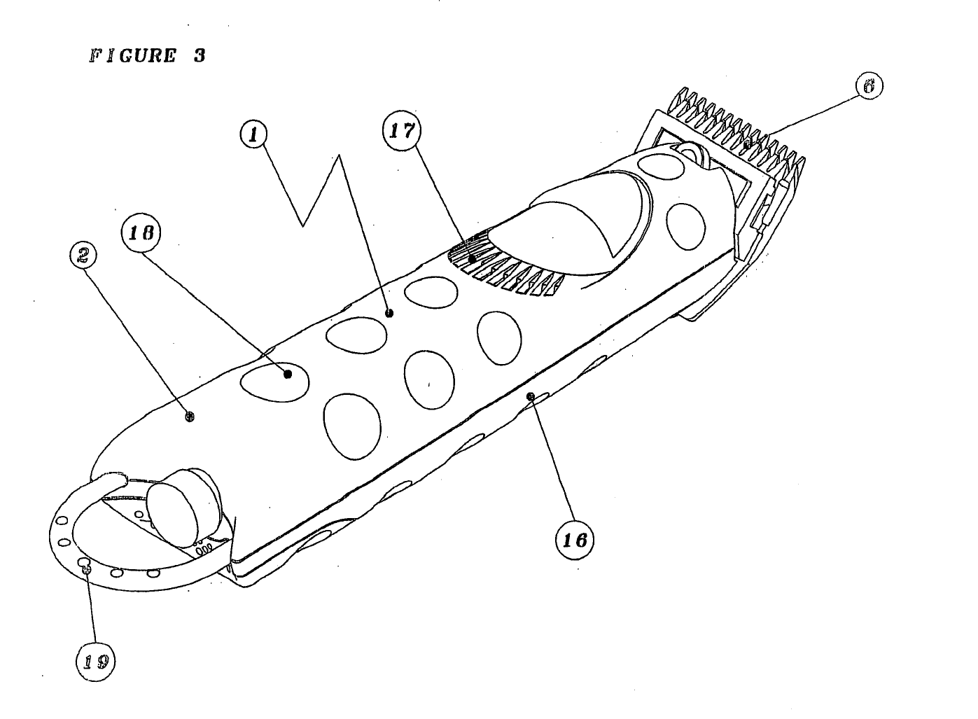

FIG. 3 shows an assembly view of a clipper according to the invention.

The handheld electric clipper 1, according to the invention, is adapted more particularly for cutting the hair of small animals. This clipper comprises a body 2 housing a low voltage electric motor 3 of a power of the order 22 watts. This electric motor 3 permits actuating, with reciprocating movement, by means of an oscillating finger 4, a cutting comb 6 at the head of the clipper. This clipper head according to that shown in FIG. 3, comprises generally two combs, one fixed, the other movable. This head generally snaps into one end of the body 2 of the clipper.

In a manner characteristic of the invention, the electric clipper 1 comprises moreover, between the output shaft 3A of the motor and the oscillating finger 4, disposed within the body 2, a planetary reducer 7 of small thickness to increase the couple between the motor output shaft 3A and the oscillating finger 4. This planetary reducer 7 permits, because of its small size, obtaining a clipper body whose dimensions are substantially identical to those of a clipper of the prior art.

As shown in FIGS. 1 and 2, the planetary reducer 7 is constituted by a stationary crown 8 disposed in the clipper body 2. This stationary crown 8 is provided internally with teeth. These interior teeth of the crown 8 coact by engagement with at least two satellites 9 themselves driven by a pinion 10 carried by the output shaft 3A of the electric motor 3. These satellites 9 have the general shape of pinions and are supported freely in rotation by a satellite carrier 11. This satellite carrier 11 has the shape of a circular plate bearing on one of its surfaces the axles 12 of the satellites 9 and on the other surface an eccentric 13 adapted to actuate the oscillating finger 4 for actuation of the clipper head.

In the illustrated examples, the eccentric 13 is positioned on a central axle 11A of the satellite carrier 11. Thus, the satellite carrier 11 is driven in rotation about an axis XX′ passing through the axle 11A, this axis XX′ being also coaxial with the motor output shaft 3A. The design of such a planetary reducer 7 permits easy reception of this latter within the interior of the frame body as well as easy assembly of the pieces constituting it.

The oscillating finger 4, driven with reciprocating movement by means of this planetary reducer 7, has itself two branches 4A, 4B interconnected at one of their ends, this common end being adapted to fit like a sleeve over an oscillation axle 5 mounted fixedly within the body 2 of the clipper. There is moreover provided, between the eccentric 13 of the satellite carrier 11 and one 4A of the branches of the finger 4, a connection piece 14 permitting the drive of the oscillating finger 4 by the eccentric 13. This connecting piece 14 here has the shape of a cube or a crosspiece. In the case of a cube, this cube comprises, on two of its adjacent orthogonal surfaces, two bearings 14A, 14B. In the case of a crosspiece, the bearings 14A and 14B are provided in two orthogonal branches of the crosspiece. The bearing 14A receives the eccentric axle 13 whilst the bearing 14B receives an axle 4C of the branch 4A of the oscillating finger. This axle 4C is perpendicular to the eccentric axle 13 and is of course parallel to the axis 5 of oscillation of the finger. The second bearing 14B thus forms a slide along the axis of the branch 4A of the finger 4 to permit oscillating movement of the finger 4. Thus the finger 4 can itself be held on the oscillation axle 5 by means of a securement ring 20.

To facilitate the cooling of a clipper of the type described above, the output shaft 3A of the motor 3 carries a ventilation fan 15. This ventilation fan 15 ensures the cooling of air about and/or through the frame of the electric motor 3. Thanks to this successive stacking of the ventilation fan 15 and the planetary reducer 7, the ventilation fan 15 and the planetary reducer 7 can be disposed within a metallic cage 21, preferably of aluminum, to promote the discharge of heat generated by the electric motor 3. This aluminum cage 21 thus forms a radiator, the fan cooling this cage so as to maintain the temperature constant. For this reason, the choice of aluminum is particularly important. The cage further comprises windows for evacuating the ventilating air and thus the heat.

To improve the presentation of the assembly, the assembly of the driven pieces and for transmitting movements of the clipper are disposed in a casing 16 constituting the external body 2 of the clipper. The casing 16 can be made of synthetic material. This casing 16 comprises, as shown in FIG. 3, grills 17 provided facing windows of the cage to cause the internal constituent elements to open the cage to communicate with the external surroundings of the clipper 1 so as again to improve the cooling of the assembly. These grills 17 are moreover positioned outside the zone of manual gripping of the clipper body and are thus positioned in the vicinity of the clipper head. These grills 17 are moreover positioned on the upper and lower surfaces of the body 2 so as to limit the risk of covering these grills.

To avoid again a poor gripping of such a clipper body, the body 2 of the clipper comprises imprints 18 marking the region of manual gripping, these imprints promoting moreover the manual gripping of the clipper without slipping. These imprints 18 are comprised by simple hallowed zones provided on the external surface of the body 2 of the clipper.

The clipper body 2 also comprises, at its end opposite the clipper head, a flexible handle 19 for suspension of the clipper from a hook. Finally, it will be noted that this clipper is provided, at its end opposite the head, with a bin serving for the connection of an electrical connection cable of the clipper to the electric grid by means of a transformer. The possibility of entirely disconnecting the cable without the permanent presence of a flexible connection cord at the end of the clipper, permits rapid changing of the supply cable. Thus, it frequently happens that the animals bite into the cable and irreversibly damage this latter. The presence of a rigid metallic bin for connection of the supply cable permits, when such an accident takes place, proceeding rapidly to change the supply cable.

The clipper thus obtained permits offering a very high quality and permits a gain of 50% in time of grooming compared to the clippers of the prior art without at the same time modifying the power of the motor used conventionally for this type of clipper.

1. Handheld electric clipper (1) for cutting particularly animal hair, of the type comprising a body (2) containing an electric motor (3) to actuate, with reciprocating movement, by means of an oscillating finger (4), a cutting comb (6) of the head of the clipper, characterized in that it comprises, between the motor output shaft (3A) and the oscillating finger (4), disposed within the body (2), a planetary reducer (7) of small thickness to increase the couple between the motor output shaft (3A) and the oscillating finger (4) and thereby to obtain a constant speed both empty and loaded, of the cutting member (6) and of the motor (3).

2. Clipper (1) according to claim 1, characterized in that the planetary reducer (7) is constituted by a stationary crown (8) disposed in the clipper body, the internal teeth of the crown (8) coacting by engagement with at least two satellites (9) themselves driven by a pinion (10) carried by the output shaft (3A) of the electric motor (3), said satellites (9) being supported freely in rotation by a satellite carrier (11) carrying on one surface the axles (12) of the satellites (9) and on the other surface an eccentric (13) adapted to strike the oscillating finger (4) for animation of the clipper head.

3. Clipper (1) according to claim 2, characterized in that the eccentric (13) is positioned on a central axle (11A) of the satellite carrier (11).

4. Clipper (1) according to claim 2, characterized in that the oscillating finger (4) has two branches (4A, 4B) and in that there is provided, between the eccentric (13) of the satellite carrier (11) and one (4A) of the branches of the finger (4), a connection piece (14) permitting the driving of the oscillating finger (4) by the eccentric (13).

5. Clipper (1) according to claim 4, characterized in that the connection piece (14) comprises two bearings (14A, 14B), one (14A) receiving the axle of the eccentric (13), the other (14B) an axle (4C) of the branch (4A) of the finger perpendicular to the axle of the eccentric (13), this second bearing (14B) forming a slide along the axle of the branch (4A) of the finger (4).

6. Clipper (1) according to claim 1, characterized in that the shaft (3A) of the motor (3) carries a ventilating fan (15) to ensure the cooling of air about and/or through the frame of the electric motor (3), at least the ventilating fan (15) and the planetary reducer (7) being disposed within a metallic cage, preferably of aluminum, to promote the evacuation of heat generated by the electric motor (3).

7. Clipper (1) according to claim 6, characterized in that the cage comprises windows for evacuation of the ventilating air and hence of heat.

8. Clipper (1) according to claim 1, characterized in that the assembly of the driven pieces and of the transmission of the movements of the clipper, are disposed in a casing (16) constituting the external body (2) of the clipper.

9. Clipper (1) according to claim 7, characterized in that the casing (16) comprises grills (17) provided facing the windows of the cage to cause the constituent elements internal to the cage to communicate with the ambient atmosphere outside the clipper (1), said grills (17) being positioned beyond the region of manual gripping of the clipper body.

10. Clipper (1) according to claim 1, characterized in that the body (2) of the clipper comprises, at its end opposite the clipper head, a flexible handle (19) for suspension of the clipper from a hook.

11. Clipper (1) according to claim 1, characterized in that the body (2) of the clipper comprises imprints (18) giving shape to the manual gripping region to promote manual gripping without slipping.

12. Clipper (1) according to claim 3, characterized in that the oscillating finger (4) has two branches (4A, 4B) and in that there is provided, between the eccentric (13) of the satellite carrier (11) and one (4A) of the branches of the finger (4), a connection piece (14) permitting the driving of the oscillating finger (4) by the eccentric (13).

13. Clipper (1) according to claim 2, characterized in that the shaft (3A) of the motor (3) carries a ventilating fan (15) to ensure the cooling of air about and/or through the frame of the electric motor (3), at least the ventilating fan (15) and the planetary reducer (7) being disposed within a metallic cage, preferably of aluminum, to promote the evacuation of heat generated by the electric motor (3).

14. Clipper (1) according to claim 3, characterized in that the shaft (3A) of the motor (3) carries a ventilating fan (15) to ensure the cooling of air about and/or through the frame of the electric motor (3), at least the ventilating fan (15) and the planetary reducer (7) being disposed within a metallic cage, preferably of aluminum, to promote the evacuation of heat generated by the electric motor (3).

15. Clipper (1) according to claim 4, characterized in that the shaft (3A) of the motor (3) carries a ventilating fan (15) to ensure the cooling of air about and/or through the frame of the electric motor (3), at least the ventilating fan (15) and the planetary reducer (7) being disposed within a metallic cage, preferably of aluminum, to promote the evacuation of heat generated by the electric motor (3).

16. Clipper (1) according to claim 5, characterized in that the shaft (3A) of the motor (3) carries a ventilating fan (15) to ensure the cooling of air about and/or through the frame of the electric motor (3), at least the ventilating fan (15) and the planetary reducer (7) being disposed within a metallic cage, preferably of aluminum, to promote the evacuation of heat generated by the electric motor (3).

17. Clipper (1) according to claim 2, characterized in that the assembly of the driven pieces and of the transmission of the movements of the clipper, are disposed in a casing (16) constituting the external body (2) of the clipper.

18. Clipper (1) according to claim 3, characterized in that the assembly of the driven pieces and of the transmission of the movements of the clipper, are disposed in a casing (16) constituting the external body (2) of the clipper.

19. Clipper (1) according to claim 4, characterized in that the assembly of the driven pieces and of the transmission of the movements of the clipper, are disposed in a casing (16) constituting the external body (2) of the clipper.

20. Clipper (1) according to claim 5, characterized in that the assembly of the driven pieces and of the transmission of the movements of the clipper, are disposed in a casing (16) constituting the external body (2) of the clipper.
